(19) United States
(12) Patent Application Publication
(10) Pub. No.: US 2025/0350686 A1
(43) Pub. Date: Nov. 13, 2025

(54) CALL NOISE REDUCTION

(71) Applicant: Anker Innovations Technology Co., Ltd., Changsha (CN)

(72) Inventors: Xiangyu Deng, Shenzhen (CN); Kai Wang, Shenzhen (CN); Jianqiang Wei, Shenzhen (CN); Libiao Yu, Shenzhen (CN)

(21) Appl. No.: 18/660,469

(22) Filed: May 10, 2024

(30) Foreign Application Priority Data
May 12, 2023 (CN) 202310538786.1

(51) Int. Cl. H04M 9/08; G10K 11/178

(52) U.S. Cl. CPC H04M 9/082; G10K 11/17823

(57) ABSTRACT

This application discloses a call noise reduction method and devices, including earphones. The method comprises: acquiring an echo cancellation reference signal, a first noise reduction reference signal received by a first microphone, and a call signal received by a second microphone; extracting a first fusion feature of the first noise reduction reference signal and the call signal, and extracting an echo signal feature of the echo cancellation reference signal; fusing the first fusion feature and the echo signal feature to generate a combined feature; and using the combined feature to perform noise reduction processing on the call signal to generate a noise-reduced call signal.

The present application claims priority to CN application Ser. No. 202310538786.1, filed on May 12, 2023. The above application is incorporated by reference in its entirety.

### FIELD

This application relates to the field of audio processing, particularly to a call noise reduction method and devices, including earphones, earbuds, in-ear monitors, headphones and the like.

### BACKGROUND

In traditional dual-mic noise reduction solutions, a combination of traditional dual-microphone beamforming, acoustic echo cancellation (ACE) and single-channel artificial intelligence (AI) noise reduction is employed. However, traditional beamforming has limited ability to distinguish human voices, which cannot effectively reduce environmental noise and other voices, resulting in limited noise reduction capabilities of existing noise reduction solutions.

### SUMMARY

This application primarily provides a call noise reduction method, devices, and earphones, addressing the issue of poor noise reduction performance in existing technologies.

To solve the aforementioned technical problem, the first aspect of this application provides a call noise reduction method, comprising: acquiring, by a call noise reduction device, an echo cancellation reference signal, a first noise reduction reference signal received by a first microphone coupled to the call noise reduction device, and a call signal received by a second microphone coupled to the call noise reduction device; extracting a first fusion feature of the first noise reduction reference signal and the call signal, and extracting an echo signal feature of the echo cancellation reference signal; fusing the first fusion feature and the echo signal feature to generate a second fusion feature; and performing, based on the second fusion feature, noise reduction processing on the call signal to generate a noise-reduced call signal.

Optionally, the extraction of the first fusion feature of the first noise reduction reference signal and the call signal comprises: processing, using a first complex convolutional network, the first noise reduction reference signal and the call signal, in order to separately obtain the first noise reduction signal feature and the call signal feature.

Optionally, the extraction of the echo signal feature from the echo cancellation reference signal comprises: processing the echo cancellation reference signal using a second complex convolutional network to generate the echo signal feature.

Optionally, the fusion of the first noise-reduced signal feature, the call signal feature, and the echo signal feature to generate the second fusion feature comprises: concatenating the first fusion feature and the echo signal feature followed by a modulus operation to generate the second fusion feature, which is a real-valued feature.

Optionally, the use of the second fusion feature to perform noise reduction on the call signal comprises: processing the second fusion feature with a convolutional neural network to generate the convolved second fusion feature; using a prediction network to process the convolved second fusion feature to generate probability results corresponding to a plurality of frequency bands; converting the call signal into a frequency domain signal, using the probability results as weights to perform a weighted summation of the frequency domain signals that fall into each frequency band, and converting the weighted summation of the frequency domain signals back into the time domain to generate the noise-reduced call signal.

Optionally, the method further comprises: obtaining a second noise reduction reference signal received by a third microphone coupled to the call noise reduction device, and extracting a second noise reduction signal feature of the second noise reduction reference signal. The fusion of the first fusion feature and the echo signal feature to obtain a second fusion feature comprises: concatenating the first fusion feature, the echo signal feature, and the second noise reduction signal feature followed by a modulus operation to obtain the second fusion feature.

Optionally, the extraction of the second noise reduction signal feature of the second noise reduction reference signal comprises: using a third complex convolutional network to process the second noise reduction reference signal to generate the second noise reduction signal feature.

Optionally, the first fusion feature comprises phase difference information between the first noise reduction reference signal and the call signal, as well as amplitude information corresponding to the first noise reduction reference signal and the call signal respectively.

To solve the above technical problems, the second aspect of this application provides a call noise reduction device, including a processor and a memory coupled to each other; the memory stores computer-readable instructions that, when executed by the processor, cause the call noise reduction device to perform the call noise reduction method provided in the first aspect of this application.

To solve the above technical problems, the third aspect of this application provides an earphone comprising a first microphone, a second microphone, and a processing unit; the first microphone is used to receive a first noise reduction reference signal, the second microphone is used to receive a call signal; the processing unit is configured to perform noise reduction processing on the call signal using the first noise reduction reference signal according to the call noise reduction method provided in the first aspect of this application.

The beneficial effect of this application is: different from the existing technology, this application first obtains the echo cancellation reference signal, the first noise reduction reference signal received by the first microphone, and the call signal received by the second microphone. Then, it extracts the first fusion feature of the first noise reduction reference signal and the call signal, extracts the echo signal feature of the echo cancellation reference signal, fuses the first fusion feature with the echo signal feature to generate the second fusion feature, and uses the second fusion feature to perform noise reduction processing on the call signal to generate a noise-reduced call signal.

### BRIEF DESCRIPTION OF THE DRAWINGS

In order to more clearly illustrate the technical solutions in the examples of this application, the following will provide a brief introduction to the drawings used in the description of the examples. It is evident that the drawings described below are only some examples of this application, and for those of ordinary skill in the art, other drawings can be obtained from these drawings without creative efforts.

FIG. 1 is a schematic flow diagram of an example of a call noise reduction method of this application;

FIG. 2 is a schematic flow diagram of an example of step S14 in this application;

FIG. 3 is a schematic flow diagram of another example of the call noise reduction method of this application;

FIG. 4 is a schematic structural diagram of an example of a call noise reduction device of this application;

FIG. 5 is a schematic structural diagram of another example of the call noise reduction device of this application;

FIG. 6 is a schematic structural diagram of yet another example of the call noise reduction device of this application;

FIG. 7 is a schematic structural diagram of an example of an earphone of this application;

FIG. 8 is a schematic structural diagram of an example of the computer-readable storage medium of this application.

### BRIEF DESCRIPTION

In conjunction with the accompanying drawings in the examples of this application, the technical solutions in the examples of this application will be clearly and completely described. It is evident that the described examples are only part of the examples of this application, and not all of them. Based on the examples in this application, all other examples that those skilled in the art can obtain without creative work fall within the scope of protection of this application.

The terms ‘first’, ‘second’, etc., in this application are used for descriptive purposes only and should not be construed as indicating or implying relative importance or implicitly indicating the number of technical features indicated. Thus, the features defined with ‘first’, ‘second’ can explicitly or implicitly comprise at least one such feature. In the description of this application, the meaning of ‘multiple’ is at least two, such as two, three, etc., unless otherwise specifically defined. Furthermore, the terms ‘comprising’ and ‘having’, and any of their variations, are intended to cover non-exclusive inclusion. For example, a process, method, system, product, or apparatus that comprises a series of steps or units is not limited to the steps or units listed but may optionally comprise steps or units not listed, or may optionally comprise other steps or units inherent to these processes, methods, products, or apparatuses.

The mention of an ‘example’ in this document means that the specific features, structures, or characteristics described in connection with the example may be comprised in at least one example of this application. The phrase does not necessarily refer to the same example at all locations in the specification, nor is it an independent or alternative example exclusive of other examples. It is explicitly and implicitly understood by those skilled in the art that the examples described herein can be combined with other examples.

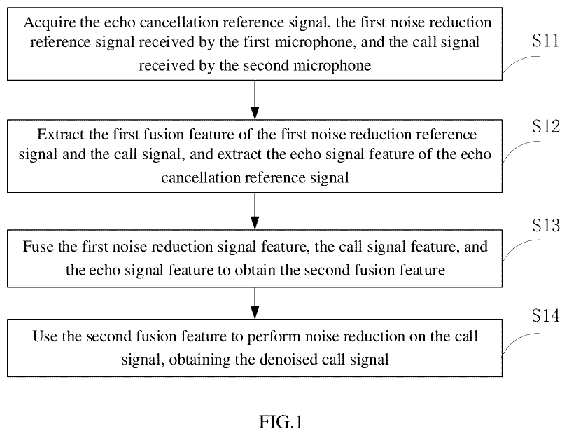

Please refer to FIG. 1, which is a flowchart schematic of an example of a call noise reduction method of this application. It should be noted that this example is not limited to the sequence of steps shown in FIG. 1 if substantially the same results can be achieved. This example comprises the following steps:

The methods disclosed in the various examples of this application can be applied to call devices including speakers and microphones, such as headphones and earphones.

Step S11: a call noise reduction device may acquire the echo cancellation reference signal, the first noise reduction reference signal received by the first microphone, and the call signal received by the second microphone. The first and second microphones may be coupled to the call noise reduction device.

The echo cancellation reference signal is generally known as the Acoustic Echo Cancellation (AEC) reference signal, which is the sound emitted from the speaker and transmitted back to the other call end through the microphone. The echo cancellation reference signal can be generated by subtracting the speaker's audio from the audio signal received by the microphone.

This example is a dual-microphone example, where the first microphone is an external microphone, mainly used for receiving environmental sound signals, and the second microphone is a call microphone, mainly used for receiving call sound signals.

Step S12: the call noise reduction device may extract the first fusion feature of the first noise reduction reference signal and the call signal, and extract the echo signal feature of the echo cancellation reference signal.

In one example, a first complex convolutional neural network can be used to process the first noise reduction reference signal and the call signal, outputting the first fusion feature of the call signal and the first noise reduction reference signal.

The first fusion feature comprises phase difference information between the first noise reduction reference signal and the call signal, as well as amplitude information corresponding to each of the first noise reduction reference signal and the call signal. Specifically, the output of the first complex convolutional neural network is complex, and the phase difference information and amplitude information can be determined through the real and imaginary parts of the complex number.

Additionally, a second complex convolutional neural network can be used to process the echo cancellation reference signal to generate the echo signal feature.

Step S13: the call noise reduction device may fuse the first noise reduction signal feature, the call signal feature, and the echo signal feature to generate the second fusion feature.

Optionally, the first noise reduction signal feature and the call signal feature can be concatenated and then a modulus operation is performed to generate the second fusion feature in real number form. Specifically, the first noise reduction signal feature and the call signal feature processed by the complex convolutional network are both in complex form, which can be directly concatenated and modulated.

In this example, after processing by the complex convolutional network, the signal is modulated to convert into real number form, so that the subsequent real number signal fusion comprises phase difference information and amplitude information. When compared to executing the algorithm in the complex domain, this application significantly reduces both memory usage and computational load. With equivalent amount of computation, this model can greatly enhance noise reduction capabilities.

Step S14: the call noise reduction device may use the second fusion feature to perform noise reduction on the call signal to generate a denoised or noise-reduced call signal.

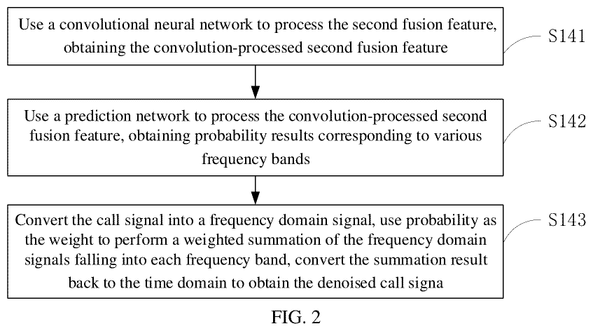

Please refer to FIG. 2, which is a schematic flow diagram of an example of step S14 of this application. It should be noted that if substantially similar results are achieved, this example is not limited to the sequence of processes shown in FIG. 2. This example comprises the following steps:

S141: the call noise reduction device may use a convolutional neural network to process the second fusion feature to generate the convolution-processed second fusion feature.

This step processes the second fusion feature to generate the feature representation of the audio signal in multiple dimensions.

S142: the call noise reduction device may use a prediction network to process the convolution-processed second fusion feature to generate probability results corresponding to various frequency bands.

The convolution-processed second fusion feature comprises a multi-dimensional feature representation of the audio signal. The convolution-processed second fusion feature is input into a pre-trained prediction network, which outputs multiple probability results corresponding to multiple frequency bands.

Specifically, the call signal, the first noise reduction reference signal, and the echo cancellation reference signal may be sampled according to a set period of time, for example, a signal sample is segmented every 10 seconds, and the prediction of the signal frequency band is carried out according to this step.

The method of frequency band segmentation can be set according to needs, and is not limited here. For example, frequencies around 1000 Hz are likely to be noise, and if this segment is set to a lower probability value, most of the noise can be removed, resulting in good noise reduction effects.

Optionally, the prediction network includes a gated recurrent neural network.

S143: the call noise reduction device may convert the call signal into a frequency domain signal, use probability as the weight to perform a weighted summation of the frequency domain signals falling into each frequency band, convert the weighted summation back to the time domain to generate the denoised call signal.

This step involves transforming the call signal into a frequency domain signal, obtaining the parts of the call signal that fall into each frequency band, and then performing a weighted summation of the call signals in each frequency band according to the corresponding probability results before converting them back to the time domain, which results in the denoised call signal.

Unlike existing technologies, this example utilizes a first complex convolutional neural network to extract features of the first denoising reference signal and the call signal, and a second complex convolutional neural network to extract features of the echo cancellation signal. The neural network processes the signal features to accomplish the denoising operation of the call signal, employing an end-to-end neural network model for processing, which is simpler in structure and does not require additional beamforming schemes and echo cancellation plans. By using different complex convolutional neural networks to fuse signals from different microphones and performing phase and amplitude encoding to the input signals, the system can effectively distinguish human voices and has strong suppression capabilities for non-human noise.

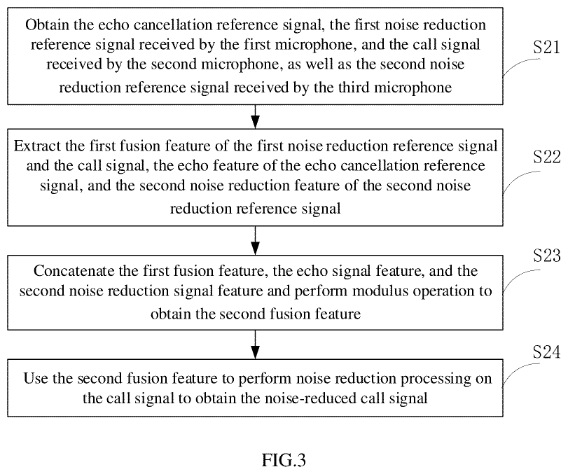

In another example, an earphone may include three microphones: the first microphone, the second microphone, and the third microphone. The first microphone, an external microphone, is mainly used to receive environmental sound signals; the second microphone, a call microphone, is primarily used for receiving call sound signals; the third microphone, an in-ear microphone, is set inside the earphone and is mainly used to receive audio signals within the earphone, which are characterized by a high signal-to-noise ratio. Please refer to FIG. 3, which is a schematic flow diagram of another example of the call noise reduction method of this application. This example may comprise the following steps:

S21: The earphones may acquire the echo cancellation reference signal, the first noise reduction reference signal received by the first microphone, and the call signal received by the second microphone, as well as the second noise reduction reference signal received by the third microphone.

The third microphone is located inside the earphones, and the audio signal it receives is mostly composed of human voice signals, with only a very small amount of environmental noise signals.

S22: The earphones may extract the first fusion feature of the first noise reduction reference signal and the call signal, the echo feature of the echo cancellation reference signal, and the second noise reduction feature of the second noise reduction reference signal.

Optionally, the earphones may use the first complex convolutional neural network to process the first noise reduction reference signal and the call signal to output the first fusion feature of the call signal and the first noise reduction reference signal; use the second complex convolutional neural network to process the echo cancellation reference signal to generate the echo signal feature; use the third complex convolutional neural network to process the second noise reduction reference signal to generate the second noise reduction signal feature.

S23: the earphones may concatenate the first fusion feature, the echo signal feature, and the second noise reduction signal feature and perform modulus operation to generate the second fusion feature.

The first fusion feature, the echo signal feature, and the second noise reduction signal feature obtained through the complex convolutional network processing are all in complex form. Direct concatenation followed by modulus operation can yield the second fusion feature in real number form.

S24: the earphones may use the second fusion feature to perform noise reduction processing on the call signal to obtain the noise-reduced call signal.

This step is similar to step S14 and is not repeated here.

Distinguished from existing technologies, this application employs neural networks to process various audio signals of headphones or earphones. Through feature extraction and audio probability calculation, it uses probability to weight the original call signal, thereby accomplishing the noise reduction operation. The model can be flexibly adjusted; when scaling up or down the number of microphones, it is only necessary to adjust the complex convolution method according to the characteristics of the microphone signals, and the subsequent network structure remains largely unchanged, ensuring simplicity and ease of adjustment.

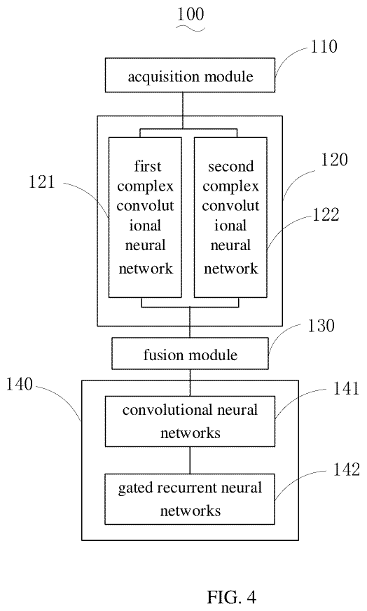

Please refer to FIG. 4, which is a schematic structural diagram of an example of a call noise reduction device of this application. The call noise reduction device 100 comprises an acquisition module 110, a feature extraction module 120, a fusion module 130, and a noise reduction module 140.

The acquisition module 110 is used to acquire the echo cancellation reference signal, the first noise reduction reference signal received by the first microphone, and the call signal received by the second microphone. The feature extraction module 120 is used to extract the first fusion feature of the first noise reduction reference signal and the call signal, and to extract the echo signal feature of the echo cancellation reference signal. The fusion module 130 is used to fuse the first fusion feature and the echo signal feature to generate the second fusion feature; the noise reduction module 140 is used to perform noise reduction on the call signal using the second fusion feature to generate a noise-reduced call signal.

Optionally, the feature extraction module 120 comprises a first complex convolutional neural network 121 and a second complex convolutional neural network 122. The first complex convolutional neural network 121 is used to extract the first fusion feature of the first noise reduction reference signal and the call signal, and the second complex convolutional neural network 122 is used to extract the echo signal feature of the echo cancellation reference signal.

The noise reduction module 140 may include interconnected convolutional neural networks 141 and gated recurrent neural networks 142.

For the specific methods of processing execution by each module, please refer to the descriptions of the steps S11˜S14 of the method example of this application mentioned above, which will not be reiterated here.

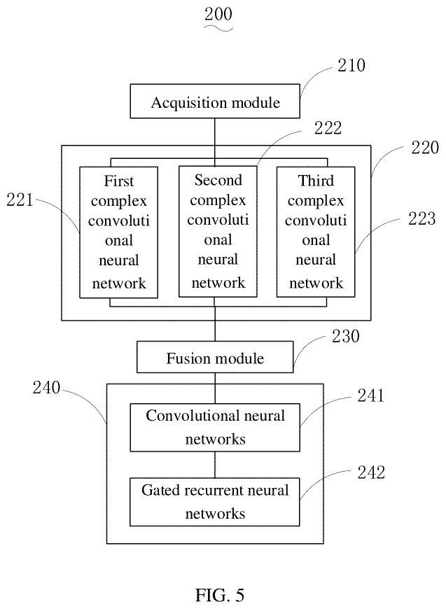

Please refer to FIG. 5, which is a schematic block diagram of another example of the call noise reduction device of this application. The call noise reduction device 200 comprises an acquisition module 210, a feature extraction module 220, a fusion module 230, and a noise reduction module 240.

The acquisition module 210 is used to acquire the echo cancellation reference signal, the first noise reduction reference signal received by the first microphone, the call signal received by the second microphone, and the second noise reduction reference signal received by the third microphone. The feature extraction module 220 is used to extract the first fusion feature of the first noise reduction reference signal and the call signal, the echo signal feature of the echo cancellation reference signal, and the second noise reduction signal feature of the second noise reduction reference signal. The fusion module 230 is used to fuse the first fusion feature, the echo signal feature, and the second noise reduction signal feature to obtain the second fusion feature. The noise reduction module 240 is used to use the second fusion feature to perform noise reduction processing on the call signal to obtain the noise-reduced call signal.

Optionally, the feature extraction module 220 comprises a first complex convolutional neural network 221, a second complex convolutional neural network 222, and a third complex convolutional neural network 223. The first complex convolutional neural network 221 is used to extract the first fusion feature of the first noise reduction reference signal and the call signal, the second complex convolutional neural network 222 is used to extract the echo signal feature of the echo cancellation reference signal, and the third complex convolutional neural network 223 is used to extract the second noise reduction signal feature of the second noise reduction reference signal.

The noise reduction module 240 may include interconnected convolutional neural networks 241 and gated recurrent neural networks 242.

For the specific methods of processing execution by each module, please refer to the descriptions of the steps of the method examples of steps S21˜S24 of this application mentioned above, which will not be reiterated here.

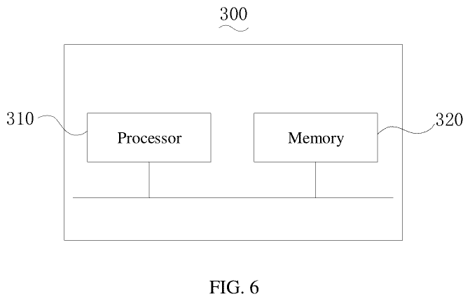

Please refer to FIG. 6, which is a schematic block diagram of another example of the call noise reduction device of this application. The call noise reduction device 300 comprises a processor 310 and a memory 320 that are coupled to each other. The memory 320 stores computer-readable instructions that, when executed by processor 310, cause the call noise reduction device 200 to implement the call noise reduction methods described in the various examples above.

For the description of the steps performed by the processor, please refer to the description of the steps of the call noise reduction method examples in this application mentioned above, which will not be repeated here.

The memory 320 can be used to store program data and modules, and the processor 310 executes various functional applications and data processing by running the program data and modules stored in the memory 320. The memory 320 may primarily comprise a program storage area and a data storage area, where the program storage area can store an operating system, applications required for at least one function (such as audio signal feature extraction function, audio noise reduction function, etc.); the data storage area can store data created based on the use of the call noise reduction device 300 (such as first noise reduction reference signal data, call signal data, etc.). In addition, the memory 320 may comprise high-speed random access memory and may also comprise non-volatile memory, such as at least one magnetic storage device, flash storage device, or other non-volatile solid-state storage device. Accordingly, the memory 320 may also comprise a memory controller to provide processor 310 access to the memory 320.

In the various examples of this application, the disclosed methods and devices can be implemented in other ways. For example, the examples of the call noise reduction device 300 described above are merely illustrative. For instance, the division of the modules or units is just one logical functional division, and in actual implementation, there can be other division methods, such as multiple units or components can be combined or integrated into another system, or some features can be omitted or not executed. Another point is that the coupling or direct coupling or communication connection shown or discussed between each other can be through some interfaces, devices, or units' indirect coupling or communication connection, which can be electrical, mechanical, or other forms.

The units described as separate components may or may not be physically separate, and the parts shown as units may or may not be physical units, i.e., they may be located in one place or distributed across multiple network units. Some or all of the units can be selected according to actual needs to achieve the objectives of this example.

Furthermore, in the various examples of this application, the functional units can be integrated into a single processing unit, can exist separately as individual physical units, or two or more units can be integrated into a single unit. The integrated unit can be implemented in the form of hardware, or in the form of software functional units.

If the integrated unit is implemented as a software functional unit and is sold or used as an independent product, it can be stored in a computer-readable storage medium. Based on such understanding, the essence of the technical solution of this application, or the part that contributes to the prior art, or all or part of this technical solution can be embodied in the form of a software product, which is stored in a storage medium.

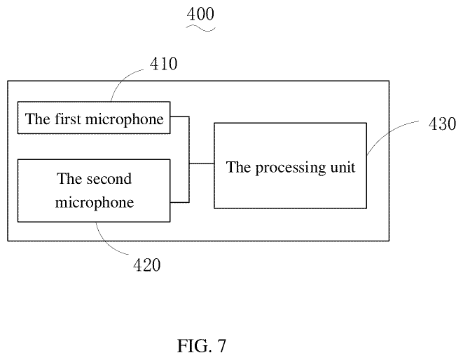

Please refer to FIG. 7, which is a structural schematic diagram of an example of the earphones in this application. The earphones 400 comprises: a first microphone 410, a second microphone 420, and a processing unit 430.

The first microphone 410 is used to receive a first noise reduction reference signal, and the second microphone 420 is used to receive a call signal. The first microphone 410 and the second microphone 420 can be connected or coupled to the processing unit 430.

The processing unit 430 is configured to perform noise reduction processing on the call signal using the first noise reduction reference signal, according to the steps of the call noise reduction method of the various examples described above.

Optionally, the earphones 400 may also comprise a third microphone (not shown in the figure), which is an in-ear microphone located inside the earphone, mainly used to receive the audio signal within the earphones, which are characterized by having a high signal-to-noise ratio.

Optionally, the earphones 400 may comprise but not limited to wired earphones, wireless wearable devices, such as wireless earphones (over-ear headphones, semi-in-ear headphones, in-ear headphones, etc.), and wireless audio glasses, etc. The earphones 400 can establish a wired or wireless communication connection with smart devices such as mobile phones, tablets, etc., to achieve remote calls through the earphones 400 and smart devices.

For the specific methods of executing each step of the processing, please refer to the description of each step of the call noise reduction method example in this application, which will not be repeated here.

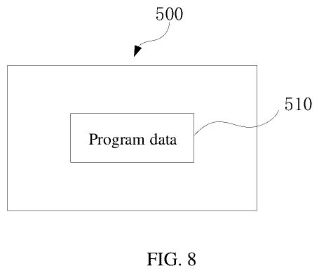

Please refer to FIG. 8, which is a schematic structural diagram of an example of a computer-readable storage medium in this application. The computer-readable storage medium 500 stores program data 510, which when executed, implements the steps of the call noise reduction method as described in the various examples above.

For a description of the steps involved in processing execution, please refer to the description of the steps of the call noise reduction method examples in this application, which will not be repeated here.

The computer-readable storage medium 500 can be a USB flash drive, portable hard drive, read-only memory (ROM), random access memory (RAM), magnetic disk, optical disk, or any other medium that can store program code.

The above description is only an example of this application and does not limit the patent scope of this application. Any equivalent structure or equivalent process transformation made using the content of the specification and drawings of this application, or direct or indirect application in other related technical fields, are similarly comprised within the patent protection scope of this application.

What is claimed:

1. A call noise reduction method, comprises:
acquiring, by a call noise reduction device:
an echo cancellation reference signal,
a first noise reduction reference signal received by a first microphone coupled to the call noise reduction device, and
a call signal received by a second microphone coupled to the call noise reduction device;
extracting a first fusion feature of the first noise reduction reference signal and the call signal, and extracting an echo signal feature of the echo cancellation reference signal;
fusing the first fusion feature and the echo signal feature to generate a second fusion feature; and
performing, based on the second fusion feature, noise reduction processing on the call signal to generate a noise-reduced call signal.

2. The method according to claim 1, wherein extracting the first fusion feature of the first noise reduction reference signal and the call signal comprises:
processing, using a first complex convolutional network, the first noise reduction reference signal and the call signal by performing complex convolutional fusion to generate the first fusion feature, wherein the first fusion feature comprises phase information and amplitude information corresponding to the first noise reduction reference signal and the call signal respectively.

3. The method according to claim 1, wherein extracting the echo signal feature of the echo cancellation reference signal comprises:
processing, using a second complex convolutional network, the echo cancellation reference signal to generate the echo signal feature.

4. The method according to claim 1, wherein fusing the first fusion feature and the echo signal feature comprises:
concatenating the first fusion feature and the echo signal feature followed by a modulus operation to generate the second fusion feature, wherein the second fusion feature comprises a real-valued feature.

5. The method according to claim 1, performing the noise reduction processing on the call signal comprises:
processing, using a convolutional neural network, the second fusion feature to generate a convolution-processed second fusion feature;
processing, using a prediction network, the convolution-processed second fusion feature to generate probability results corresponding to a plurality of frequency bands;
transforming the call signal into a frequency domain signal by:
performing, using the probability results as weights, a weighted summation of the frequency domain signals falling into each of the plurality of frequency bands; and
converting the weighted summation of the frequency domain signals back to a time domain to generate the noise-reduced call signal.

6. The method according to claim 1, the method further comprises:
acquiring a second noise reduction reference signal received by a third microphone coupled to the call noise reduction device; and
extracting a second noise reduction signal feature of the second noise reduction reference signal,
wherein fusing the first fusion feature and the echo signal feature to generate the second fusion feature comprises:
concatenating the first fusion feature, the echo signal feature, and the second noise reduction signal feature followed by a modulus operation to generate the second fusion feature.

7. The method according to claim 6, wherein extracting the second noise reduction signal feature of the second noise reduction reference signal comprises:
processing, using a third complex convolutional network, the second noise reduction reference signal to generate the second noise reduction signal feature.

8. The method according to claim 1, wherein the first fusion feature comprises:
phase difference information between the first noise reduction reference signal and the call signal, and
amplitude information corresponding to the first noise reduction reference signal and the call signal, respectively.

9. A call noise reduction device comprising:
a processor and a memory coupled to the processor, the memory storing computer-readable instructions that, when executed by the processor, cause:
acquiring an echo cancellation reference signal, a first noise reduction reference signal received by a first microphone coupled to the call noise reduction device, and a call signal received by a second microphone coupled to the call noise reduction device;
extracting a first fusion feature of the first noise reduction reference signal and the call signal;
extracting an echo signal feature of the echo cancellation reference signal;
fusing the first fusion feature and the echo signal feature to generate a second fusion feature; and
performing, based on the second fusion feature, noise reduction processing on the call signal to generate a noise-reduced call signal.

10. The call noise reduction device according to claim 9, wherein the instructions, when executed by the processor, further cause extracting the first fusion feature of the first noise reduction reference signal and the call signal by:
processing, using a first complex convolutional network, the first noise reduction reference signal and the call signal by performing complex convolutional fusion to generate the first fusion feature, wherein the first fusion feature comprises phase information and amplitude information corresponding to the first noise reduction reference signal and the call signal respectively.

11. The call noise reduction device according to claim 9, wherein the instructions, when executed by the processor, further cause extracting the echo signal feature of the echo cancellation reference signal by:
processing, using a second complex convolutional network, the echo cancellation reference signal to generate the echo signal feature.

12. The call noise reduction device according to claim 9, wherein the instructions, when executed by the processor, further cause fusing the first fusion feature and the echo signal feature by:
concatenating the first fusion feature and the echo signal feature followed by a modulus operation to generate the second fusion feature, wherein the second fusion feature comprises a real-valued feature.

13. An earphone comprising a first microphone, a second microphone, and a processing unit, wherein:
the first microphone receives a first noise reduction reference signal;
the second microphone receives a call signal; and
the processing unit is configured to:
acquire an echo cancellation reference signal, the first noise reduction reference signal, and the call signal;
extract a first fusion feature of the first noise reduction reference signal and the call signal;
extract an echo signal feature of the echo cancellation reference signal;
fuse the first fusion feature and the echo signal feature to generate a second fusion feature; and
perform, based on the second fusion feature, noise reduction processing on the call signal to generate a noise-reduced call signal.

14. The earphone according to claim 13, wherein the processing unit is further configured to extract the first fusion feature of the first noise reduction reference signal and the call signal by:
processing, using a first complex convolutional network, the first noise reduction reference signal and the call signal by performing complex convolutional fusion to generate the first fusion feature, wherein the first fusion feature comprises phase information and amplitude information corresponding to the first noise reduction reference signal and the call signal respectively.

15. The earphone according to claim 13, wherein the processing unit is further configured to extract the echo signal feature of the echo cancellation reference signal by:
processing, using a second complex convolutional network, the echo cancellation reference signal to generate the echo signal feature.

16. The earphone according to claim 13, wherein the processing unit is further configured to fuse the first fusion feature and the echo signal feature by:
concatenating the first fusion feature and the echo signal feature followed by a modulus operation to generate the second fusion feature, wherein the second fusion feature comprises a real-valued feature.

17. The earphone according to claim 13, wherein the processing unit is further configured to perform the noise reduction processing on the call signal by:
processing, using a convolutional neural network, the second fusion feature to generate a convolution-processed second fusion feature;
processing, using a prediction network, the convolution-processed second fusion feature to generate probability results corresponding to a plurality of frequency bands;
transforming the call signal into a frequency domain signal by:
performing, using the probability results as weights, a weighted summation of the frequency domain signals falling into each of the plurality of frequency bands; and
converting the weighted summation of the frequency domain signals back to a time domain to generate the noise-reduced call signal.

18. The earphone according to claim 13, wherein the earphone further comprises a third microphone, and wherein the processing unit is further configured to:
acquire a second noise reduction reference signal received by the third microphone; and
extract a second noise reduction signal feature of the second noise reduction reference signal,
wherein fusing the first fusion feature and the echo signal feature to generate the second fusion feature comprises:
concatenating the first fusion feature, the echo signal feature, and the second noise reduction signal feature followed by a modulus operation to generate the second fusion feature.

19. The earphone according to claim 18, wherein the processing unit is further configured to extract the second noise reduction signal feature of the second noise reduction reference signal by:
processing, using a third complex convolutional network, the second noise reduction reference signal to generate the second noise reduction signal feature.

20. The earphone according to claim 13, wherein the first fusion feature comprises:
phase difference information between the first noise reduction reference signal and the call signal, and
amplitude information corresponding to the first noise reduction reference signal and the call signal, respectively.
